(19) United States
(12) Patent Application Publication
(10) Pub. No.: US 2005/0033731 A1
(43) Pub. Date: Feb. 10, 2005

(54) Priority-based search for combinatorial optimization problems

(76) Inventors: Neal B. Lesh, Cambridge, MA (US); Michael D. Mitzenmacher, Lexington, MA (US)

Correspondence Address: Patent Department;Mitsubishi Electric Research Laboratories, Inc., 201 Broadway, Cambridge, MA, 02139, US

(21) Appl. No.: 10/634,280

(22) Filed: Aug. 5, 2003

(51) Int. Cl. G06F 7/00

(52) U.S. Cl. 707/2

(57) ABSTRACT

A method solves a combinatorial optimization problem including multiple elements and values. An ordering function is applied to an instance of the combinatorial optimization problem to produce an ordering of elements. The ordering of the elements is modified repeatedly to produce a re-ordering of the elements. A placement function is applied to each re-ordering of the elements to obtain solutions of the combinatorial optimization problem, until a termination condition is reached, and a best solution is selected.

### FIELD OF THE INVENTION

The invention relates generally to combinatorial optimization problems, and more particularly to search techniques for finding optimal solutions.

### BACKGROUND OF THE INVENTION

Combinatorial problems deal with applications where multiple elements, e.g., items or tasks, can be combined or performed in various orders. If the number of elements and possible orderings is large, these problems are extremely difficult to solve.

Well known combinatorial problems include the traveling salesman and delivery truck problems, transportation scheduling (airline, trains, buses), job shop scheduling, class and student scheduling, utility management (power, gas, water, sewage), load balancing in power and communications networks, finding the best locations of cell towers, and most packing or lay-out problems.

For many combinatorial optimization problems, it is necessary to search a very large number of possible solutions for an optimal best solution. One type of search is a greedy search. Greedy searches usually find the optimal or global solution for some problems, but may find less-than-optimal solutions for some instances of other problems.

A subclass of the greedy search is conventionally known as a priority algorithms, see Angelopoulos et al., “On the Power of Priority Algorithms for Facility Location and Set Cover,” APPROX, pp. 26-39 2002, and Borodin et al., “(Incremental) Priority Algorithms,”SODA, pp. 752-761, 2002. Priority algorithms are especially effective for solving combinatorial packing problems and scheduling problems. They are also fast and easy to implement.

Priority algorithms can be classified as fixed or dynamic. A fixed priority algorithm assigns all priorities at design time, and those priorities remain constant. That is, the fixed priority algorithm requires an ordering of all elements in the problem instance. The algorithm is greedy. This means that the value assigned to xᵢ is only a function of previously assigned elements and the value of an element is fixed after it is decided. Fixed-priority algorithms tend to be the simplest to implement.

A dynamic priority algorithm assigns priorities at run time, based on execution parameters. In the dynamic priority algorithm, the remaining elements are re-ordered after the placement of an element according to run time dynamics. As a general characteristic of prior art priority algorithms, the highest-priority element is always placed at each step. As the invention shows, this may not be desirable in all cases.

As shown in FIG. 1, a typical priority algorithm 100 for an optimization problem 101 starts with an instance I 102 of the problem. An ordering function o 110 produces an ordered list of elements 103. A placement function ƒ 120 takes the ordered elements, one-by-one to produce a solution S 104. The placement function maps a partial solution and an element to a priority value for that element. If the priority function is dynamic, then step 110 is repeated after placing an element.

However, it is possible that even better solutions exist ‘near’ good solutions found by priority algorithms. Therefore, it is desired to improve priority algorithms to search for these better solutions.

### SUMMARY OF THE INVENTION

For combinatorial problems, a priority algorithm usually finds a good solution. However, there are often better solutions ‘nearby’. The invention provides a natural and generic approach to find these better solutions.

In the priority algorithm according to the invention, an ordering function produces an ordering for an instance of the problem. The ordering is then modified in a special way to produce additional orderings ‘near’ to the initial ordering. A process for re-ordering and a distance metric for nearness is provided. Then, a placement function of the priority algorithm is applied to the modified ordering to find a better solution. In particular, the measure of nearness uses the Kendall-tau distance. Other distance metrics can also be used.

The method according to the invention can use an exhaustive or a random modification. As an advantage, the modification of the ordering according to the invention is independent of the application domain, while the particular ordering and placement functions for a conventional priority algorithm are usually constructed to be effective for a particular application domain.

The invention does not require any additional domain-specific knowledge. A generic implementation of the invention treats the components of the priority algorithm as black boxes. Thus, the invention can be applied to any application that uses a priority algorithm, e.g., rectangular strip packing, jobshop scheduling, edge crossing, and number partitioning.

### BRIEF DESCRIPTION OF THE DRAWINGS

FIG. 1 is a flow diagram of a prior art priority algorithm; and

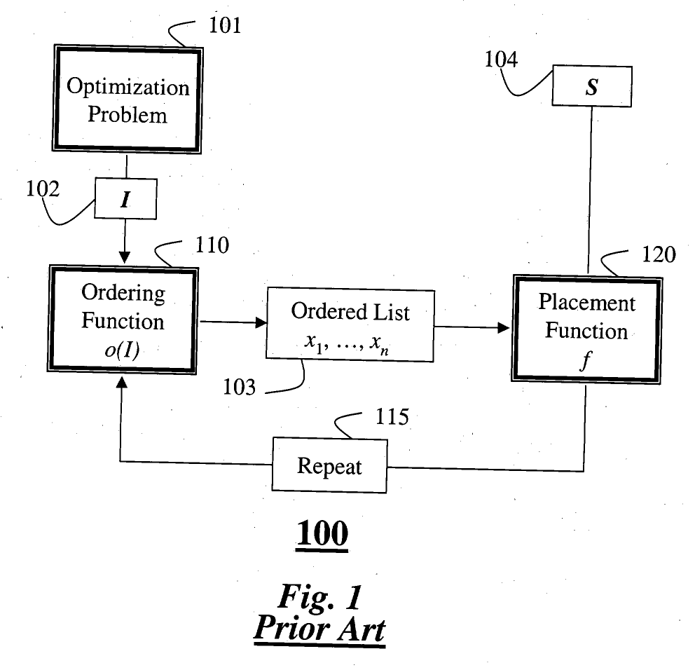

FIG. 2 is a flow diagram of a priority algorithm according to the invention.

### DETAILED DESCRIPTION OF THE PREFERRED EMBODIMENT

Priority Algorithm

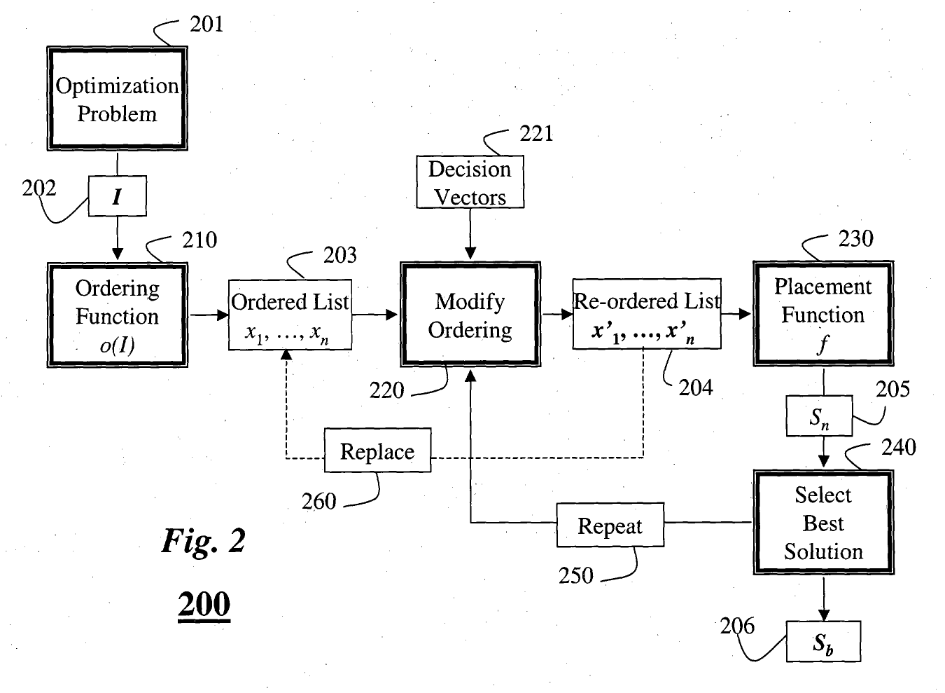

As shown in FIG. 2 for a priority algorithm 200 according to the invention, a combinatorial optimization problem 201 is characterized by a universe U of elements E, and a universe V of values.

A problem instance I 202 includes a subset of elements E ⊂ U. A solution is a mapping of elements in E to values in V. The problem definition also includes a total ordering, with ties, on solutions. Because only a subset of the elements in E may have values, partial solutions exist.

An ordering function o 210 maps the problem instance I 202 to an ordered sequence of the elements x₁, . . . xₙ 203 in I.

The order of the elements is modified 220 as described in greater detail below. The sequence 204 can be called a nearby ordering. The effect of the re-ordering is that the highest priority element is not necessarily placed first, as in the case of the prior art.

A placement function ƒ 230 is applied to the re-ordered elements x′₁, . . . , x′ₙ204 to generate a solution Sₙ 205. The placement function maps a partial solution and an element to a priority value for that element.

Then, the modifying, and placing steps are repeated 250, for the same ordering 203 but different nearby re-orderings 204, until a termination condition 240 is satisfied, e.g., a best solution S_{b} 206 is selected, or a predetermined number of iterations is reached.

Modified Orderings

Instead of using the ordering 203 provided by the ordering function 210, the priority algorithm according to the invention modifies 220 to generate the re-ordered list 204. The re-ordered list does not necessarily have the highest-priority element as the first element in the list for placement, and the placement function is applied only after re-ordering.

As stated above, there are often better solutions ‘nearby’. The modification step 220 provides such nearby solutions. Such solutions are obtained from re-orderings that are near the ordering 203.

Kendall-tau distance

In order to understand the “nearness’ of re-ordered list, as distance metric is provided, preferably the Kendall-tau or ‘bubble-sort’ distance, see Stuart, Kendall's tau, Kotz et al., editors, Encyclopedia of Statistical Sciences, Volume 4, pp. 367-369, John Wiley & Sons, 1983, other distance metrics such as Spearman-rho, Goodman-Kruskal gamma, and Yule Q can also be used.

Formally, the Kendall-tau distance is defined as follows. Consider two orderings π and σ of an underlying set {x₁; xₙ}. If π(i) is the position of xᵢ in the ordering, then the Kendall-tau distance

$${d}_{Ken} ( π , σ ) = {\sum }_{1 \leq i \leq j \leq n} I [ π ( i ) < π ( j ) and σ ( i ) > σ ( j ) ] ,$$

where I[z] is 1 when expression z is true, and 0 otherwise. Informally, the Kendall-tau distance is the minimum number of transpositions needed to transform the ordering π to the ordering σ.

Modification Method

The modification can be done in a number of different ways. One way is to randomize the ordering to obtain the nearby orderings, and then to measure the distance between the ordering 203 and the nearby ordering to see if any are acceptable. However, this process may do extra work.

Decision Vector

In the preferred embodiment, the modifying step 220 applies decision vectors a 221 to the ordering σ 203 of elements x₁, . . . , xₙ, such a value |a−1ₙ| is the Kendall-tau distance between π and the re-ordering a 204, where the norm is the L1 distance, and 1ₙ is an all-ones vector (1, 1, . . . , 1). As an advantage, the decision vector can be predetermined to meet the distance metric. In other words, the re-ordering is performed in a controlled manner.

In addition, the decision vector a with fields (a₁, a₂, . . . , aₙ) allows the modifying to be generalized for both fixed and dynamic priority algorithms. The field aⱼ represents the remaining element to consider at selection step in the reordering. If field aⱼ=k, then the k^{th}-highest-priority element is placed in step j.

With the above definitions, and in context with the invention, priority algorithms can be characterized, in the context of the invention, by how they select decision vectors to evaluate. For example, the fixed and dynamic priority algorithms evaluate a single ordering corresponding to an all-ones decision vector 1ₙ=(1, 1, . . . , 1), i.e., the modifying step is a null operation.

Anytime Priority Algorithm

In addition, the invention enables a new class of priority algorithm, namely ‘anytime’ priority algorithms. In computer processing generally, an anytime process can be stopped after any number of iterations and still produce a valid result.

The anytime priority algorithm is an extension of a fixed or dynamic priority algorithm. As the name implies, the anytime algorithm can be halted after any number of iterations, and returns the best solution it has evaluated so far. This is in contrast with prior art priority algorithms, which must always complete.

The anytime priority algorithm applies the placement function to random orderings. In terms of decision vectors, this corresponds to selecting each element aᵢ independently and uniformly at random from [1, n−i+1]. The totally random anytime priority algorithm continues to apply its placement function to new orderings of the problem elements until terminated.

Exhaustive Priority Algorithm

An ‘exhaustive’ anytime priority algorithm considers eventually all possible n! decision vectors with 1≦_aᵢ≦n−i+1. This set of vectors produces re-orderings is Oₙ. Considering all n! decision vectors is impractical. Therefore, the order in which the decision vectors are evaluated is important for performance. The invention defines a total ordering on Oₙ as:
a<b if |a−1ₙ|<|b−1ₙ|
if |a−1ₙ|=|b−1ₙ|, then a<b is true if and only if a comes before b in the lexicographic ordering for vectors. The intuition for this total ordering on decision vectors is derived from fixed priority algorithms. In other words, the invention searches outward from the ordering in according to increase Kendall-tau distances. For example, transposing each pair of adjacent elements, then transpose elements one apart, and then two apart, and so forth.

Probabilistic Priority Algorithm

For some problems, small perturbations to an element ordering tend to make only a small difference in the quality of the solution. In this case, larger perturbations can be more effective. This motivates a probabilistic search strategy. This strategy selects decision vectors at each step randomly according to some probability distribution.

In terms of the decision vector, the decision vector a is selected with a probability proportional to g(|a−1ₙ|) for some function g, e.g., the function (1−p)^{|a-1}^{_{n|}} for some parameter p. This determines how near the ordering the randomly elected orderings tend to be. In the case of the fixed priority algorithm, this has the following interpretation.

If r is the ordering, then at each step an ordering σ is selected a probability proportional to (1−p)^{dKen(τ,σ)}. To select the decision vector according to the above distribution, each aᵢ is determined as follows. Initially, q is 0. Repeat the following: select with probability p, terminate and output aᵢ=q+1; otherwise increment q by 1, modulo n−i+1.

In other words, the first element x₁ of the ordering 203 is selected to be the first element x′₁ of the nearby ordering with a probability p. If the element is not selected, then the next element is tried, and so forth, until the last element of the ordering is reached, and then to repeat the probabilistic selection from the top, until all elements of the ordering have been moved to the nearby ordering. Here, the value of the probability controls how close the re-ordering is to the ordering.

Both an exhaustive and probabilistic algorithms apply equally well to dynamic priority algorithms. Because the ordering changes as elements are placed, this ordering cannot be tied directly to the Kendall-tau distance between orderings, as in the case of the fixed priority algorithm.

Other variations include the following. There can be several ordering functions, with the search cycling though the functions, or apply several ordering functions in parallel. There can also be several placement functions.

For some constant k, the last k fields of the decision vector can be truncated, so that the exhaustive search is only on the first n−k fields. Alternatively, all possible values for only the last k fields can be considered. This can be done by setting the corresponding fields to zero.

In addition, the ordering 203 can be replace 260 when a particular re-ordering leads to a better solution than that corresponding re-ordered list can replace the ordering. Decision vectors are then applied from the new ordering. For an exhaustive search, the decision vector is restarted from the all-ones vector, in this case.

### EFFECT OF THE INVENTION

The invention exploits the fact that often better solutions exist near an ordering of a priority algorithm. The placement function and the ordering of most priority algorithms encode valuable domain-specific knowledge for solving the problem. However, applying the placement function only to the ordering does not fully exploit this knowledge.

The invention exploits the knowledge in priority functions. The search according to the invention can be extended to any priority algorithm. For many practical problems, the search according to the invention can significantly improve the solution found by a priority algorithm dramatically after evaluating only a small number of re-orderings. In particular, the average result of the randomized search can be as much as 20% better than the average result obtained by a prior art priority algorithm for some problems. The results continue to improve as the search evaluates additional orderings.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention

1. A method for solving a combinatorial optimization problem including a plurality of elements and a plurality of values, comprising:
applying an ordering function to an instance of the combinatorial optimization problem to produce an ordering of the elements;
modifying the ordering of the elements to produce a re-ordering of the elements;
applying a placement function to map values to the corresponding elements of the re-ordering; and
repeating the modifying and the applying until all elements have been placed to obtain a solution of the combinatorial optimization problem.

2. The method of claim, in which the priority algorithm is fixed.

3. The method of claim, in which the priority algorithm is dynamic.

4. The method of claim 1, in which the re-ordering is within a predetermined distance of the ordering.

5. The method of claim 4, in which the distance is a Kendall-tau distance.

6. The method of claim 1, in which the re-ordering uses a decision vector, and in which the distance vector has one field for each element of the order, each field determining a new order of the element in the re-ordering.

7. The method of claim 1, in which the re-ordering is probabilistic.
